(19) United States
(12) Patent Application Publication
(10) Pub. No.: US 2007/0178885 A1
(43) Pub. Date: Aug. 2, 2007

(54) Two-phase SIM authentication

(75) Inventor: Guy Lev, Alfei-Menashe (IL)

Correspondence Address: Martin D. Moynihan;PRTSI, Inc., P.O. Box 16446, Arlington, VA, 22215, US

(73) Assignee: StarHome GmbH, Zurich (CH)

(21) Appl. No.: 11/604,832

(22) Filed: Nov. 28, 2006

Related U.S. Application Data
(60) Provisional application No. 60/739,932, filed on Nov. 28, 2005.

(51) Int. Cl. H04M 1/66

(52) U.S. Cl. 455/411; 713/168

(57) ABSTRACT

A method for challenge-based authentication of a communication entity to an access network. The access network uses a password-based communication protocol. The method comprises a) pre-supplying to the communication entity a challenge, thereby allowing the communication entity to provide a challenge response, b) supplying to the communication entity a password request, c) receiving the challenge response via the password request, and d) authenticating the communication entity if the challenge response is correct. Presupplying may be during a previous IP session, wherein communication entities are simply given challenges for next time they connect to the hotspot. Alternatively presupplying could be during a brief probationary connection that the access network gives to its users.

### RELATIONSHIP TO EXISTING APPLICATION

The present application claims the benefit of U.S. Provisional Patent Application No. 60/739,932, filed on Nov. 28, 2005, the contents of which are hereby incorporated by reference.

### FIELD AND BACKGROUND OF THE INVENTION

The present invention relates to a network-access authentication process through a hotspot or the like and, more particularly, but not exclusively to authentications which are performed using the hotspot radius protocol.

Computer network-access through public access points, such as Wi-Fi Hotspots, is becoming increasingly common through services being provided by local enterprises, independent carriers, and Internet Service Providers (ISPs). The public access points are usually supported by IEEE specification for WLAN that is known as 802.11x. This specification 802.11x offers to some extent authentication and access control mechanisms as well as confidentiality, but only in the wireless path.

Moreover, recently Worldwide Interoperability for Microwave Access (WiMAX) has been employed as a technology to link hotspots, primarily as a component in Wireless ISPs or WISPs.

As of today, the most common method for securing access to such a wireless network is to protect access with a password. However, passwords have several notable disadvantages. Passwords are relatively easy to intercept and therefore considered unsafe. Moreover, in order to maintain a relatively high security level, passwords have to be changed on a regular basis and kept secret. This is compounded by the fact that regular users of hotspots may be required to have a different password for each hotspot, and irregular users face the inconvenience of having to register for passing use.

One process, which has been implemented in order to avoid using passwords for acquiring network-access, is the SIM-based authentication procedure used in the Global System for Mobile Communications (GSM). The SIM-based authentication procedure offers a secure alternative in which identification is based on a unique number, which is stored in a GSM subscriber identification module (SIM) card or in a general packet radio service (GPRS) SIM card of a certain subscriber.

The SIM card securely stores a secret key identifying a mobile phone service subscriber, as well as subscription information, preferences, text messages and other information. The equivalent of a SIM in universal mobile telecommunications system (UMTS) is a universal SIM (USIM). As well as the secret key, SIM cards identify users uniquely by holding an international mobile subscriber identity (IMSI).

There are three major components which takes part in the SIM-based authentication procedure: a communication entity, such as a mobile phone (MS), that has a SIM card which provides the user's unique identities, secret and otherwise, a base station subsystem (BSS), including a VLR (visitor location register) and MSC (mobile switching center) which connects the user on a mobile station to other mobile/landline users, and the home location register (HLR).

The SIM-based authentication procedure on GSM networks checks the validity of the subscriber's SIM card and then decides whether the communication entity is allowed on a particular network access or connection. The parties involved in the authentication process are: a) the end user or holder of the SIM card b) the home location register (HLR) of a network operator, such as a GSM service provider, and the VLR/MSC. The user is authenticated to the operator via the SIM based authentication, authorization, and accounting (AAA) mechanism. The network authenticates the subscriber by a challenge-response method that comprises the following steps:
1. When a subscriber wants to establish a connection, the communication entity sets up a link to the VLR/MSC, and relays the international mobile subscriber identity (IMSI) or a temporary mobile subscriber identity (TMSI) from the SIM to the VLR/MSC. The VLR/MSC uses the IMSI to identify the appropriate HLR and makes an authentication request, typically using SS7 messaging, to the HLR.
2. The HLR has the user's card specific secret key Ki, and generates a random number (Rand) as the challenge. The HLR produces the challenge response (SRes) and sends the challenge, the calculated challenge response and a communication key (Kc) as a triplet, the GSM triplet, to the MSC/VLR.

The communication entity receives the challenge from the MSC VLR. Typically a 128-bit random number (RAND), which is transmitted through the air interface and passed to the SIM card. At the SIM card, the challenge is sent through the so-called A3 algorithm together with the card specific secret key (Ki). The SIM card is now expected to produce SRes. Provided that the SIM card knows the correct Ki, then the output of the A3 algorithm is the signed response (SRES). The SIM card then uses the so-called A8 algorithm with challenge and Ki to compute the temporary ciphering key (Kc), which is used to encrypt data for transmission back through the air interface. The triplet (RAND, SRES, and Kc) is called the GSM triplet.
3. The result of the A3 algorithm is a cipher text block, SRES, which is transferred from the mobile station to the base station and MSC/VLR via the air interface.
4. The HLR has already derived SRes independently, as described above and sent it to the VLR/MSC.
5. The SRES sent to the VLR/MSC is then compared with the SRES' sent in the original triplet to the VLR/MSC to authenticate the subscriber and thus authorize the request to establish a connection. Note that the SIM card's secret key Ki is not transmitted anywhere, and the A3 algorithm is a one-way algorithm such that Ki is never derivable from SRes.

As such, SIM-based authentication procedure requires bidirectional communication between the communication entity and the base station. Thus SIM-based authentication cannot be implemented via a hotspot or any other access point that is configured according to the commonly used protocols. Such a hotspot does not permit bidirectional communication with the communication entity before it has been authenticated and therefore the random number is not forwarded to the communication entity to allow it to generate SRES.

A small number of hotspots do allow the implementation of SIM-based authentication process via hotspots. The Extensible authentication protocol (EAP) method for SIM (EAP-SIM) authentication, and the EAP method for UMTS authentication, and key agreement (EAP-AKA) authentication are standard formats for these kind of hotspots, which are used for implementing SIM-based authentication procedures.

An example of implementation of such a SIM-based authentication is disclosed in Patent Application No. 2006/0046693 published on Mar. 2, 2006. The Patent Application discloses a method, WLAN client, and WLAN service node (WSN) that allows an EAP-SIM module of the WLAN client to extract subscriber credentials from a SIM card, and to package the credentials into the EAP-SIM format and further into the TCP/IP format, before sending them to the WSN via a serving access point. The WSN receives the credentials and unpacks them from the TCP/IP format and further from the EAP-SIM format, and authenticates/authorizes the WLAN client. WLAN access is authorized for the WLAN client upon successful authorization.

The aforementioned methods and systems can however only be implemented on a hotspot or an access point that supports Wi-Fi protected access (WPA) protocols or on a hotspot with an EAP-SIM-based authentication process in the GSM networks. Such protocols are not currently widely supported and thus, most existing hotspots and access points cannot implement such SIM-based authentications without substantial hardware or firmware modification.

There is thus a widely recognized need for, and it would be highly advantageous to have, a way for allowing bi-directional authentication of network subscribers, for use at conventional hotspots, which is devoid of the above limitations.

### SUMMARY OF THE INVENTION

According to one aspect of the present invention there is provided a method for challenge-based authentication of a communication entity to an access network, the access network using a password-based communication protocol. The method comprises: a) pre-supplying to the communication entity a challenge, thereby allowing the communication entity to provide a challenge response, b) supplying to the communication entity a password request, c) receiving via the password request the challenge response, and d) authenticating the communication entity if the challenge response is correct.

Preferably, the pre-supplying is performed via an IP-based network connection, to provide the communication entity with challenges for future connections to access networks.

More preferably, the pre-supplying comprises pre-supplying multiple challenges to the communication entity.

Preferably, communication entity comprises a member of the following group: a subscriber identification module (SIM) card and a universal SIM card.

More preferably, the authenticating comprises checking that the SIM card is still valid by requesting a new challenge substantially simultaneously with the authentication.

Preferably, the pre-supplying is via a temporary IP session on the access network.

Preferably, the challenge is a GSM authentication challenge.

More preferably, the method further comprises a step before step a) of receiving an international mobile subscriber identity (IMSI).

More preferably, the method further comprises a step before step a) of using the IMSI to obtain the challenge.

Preferably, the communication entity comprises a member of the following group: a laptop, a notebook computer, a notebook computer equipped with personal computer memory card industry association (PCMCIA) card, a dual-mode phone, a wireless personal digital assistant (PDA), a mobile phone with a wireless local area network (WLAN) connection, and an arrangement of a SIM based mobile phone and a communication device with a WLAN connection.

Preferably, the challenge is acquired from a home location register (HLR) of a cellular network.

More preferably, the challenge is a random number challenges (RAND) of a GSM triplet generated by the HLR.

More preferably, the challenge response is a signed response (SRES) of a GSM triplet generated by the HLR.

According to another aspect of the present invention there is provided an authentication server for managing challenge based authentication from a cellular network on access networks configured for password-based authentication. The server comprises a pre-supply unit for pre-supplying a challenge to a communication entity, a credential-receiving unit for receiving data sent as a password to the access network as a response to the pre-supplied challenge, and an authorization unit for authorizing the authorization unit if the credentials correctly correspond to the pre-supplied challenge.

Preferably, the pre-supply unit is configured to send the challenge via predefined IP-based connection.

Preferably, the pre-supply is configured to pre-supply the challenge to the communication entity by opening a temporary IP connection over an access unit.

Preferably, the pre-supply unit is configured to send the challenge as a response to an authorization request that is received from the communication entity.

Preferably, the pre-supply unit is configured to communicate with a home location register (HLR) of a cellular network.

Preferably, the challenge is a random number challenges (RAND) of a GSM triplet generated by the HLR.

According to another aspect of the present invention there is provided a subscriber information module (SIM)-card based client for acquiring a network access, the SIM-card based client comprises a challenge request module for acquiring a GSM challenge, a challenge response module configured for generating a challenge response, and a response module for sending the challenge response as a password in a post request, thereby carrying out bi-directional authentication over a password-enabled access connection.

Preferably, the SIM card based client further comprises a cache for storing the challenge until authorization is required.

Preferably, the SIM-card has an international mobile subscriber identity (IMSI), the challenge request module being configured to send the IMSI as a credential a username password post request.

Preferably, the GSM challenge is acquired via an IP-based connection.

Preferably, the IP-based connection is a direct connection with an authentication, authorization, accounting (AAA) server of a cellular network.

Preferably, the challenge request module is configured to instruct the AAA server to establish a temporary connection, the acquiring being via the temporary connection.

Preferably, the SIM-card based client is a member of the following group: a laptop, a notebook computer, a notebook computer equipped with personal computer memory card industry association (PCMCIA) card, a dual-mode phone, a wireless personal digital assistant (PDA), a mobile phone with a wireless local area network (WLAN) connection, and an arrangement of a SIM based mobile phone and a communication device with a WLAN connection.

According to another aspect of the present invention there is provided an access point for authenticating an access network for a communication entity. The access point comprises a temporary access module for: a) communicating with a cellular authorization authority to provide the communication entity with a temporary connection, and b) to allow uploading a challenge to the communication entity during the temporary connection.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic illustration of an authentication node for SIM-based authentication for access to a network, according to a preferred embodiment of the present invention;

FIG. 2 is an exemplary high-level network diagram of a system for authenticating access to a network, according to one preferred embodiment of the present invention;

FIG. 3 is a simplified sequence chart that depicts an a SIM-based authentication sequence, according to one preferred embodiment of the present invention;

FIGS. 4A and 4B are respectively flowcharts of the first and the second stages of an exemplary method for enabling network-access to a communication entity, according to a preferred embodiment of the present invention;

FIG. 5 is another simplified sequence chart that depicts another SIM-based authentication sequence, according to one preferred embodiment of the present invention; and

FIGS. 6A and 6B are respectively flowcharts of the first and the second stages of another exemplary method for enabling network-access to a communication entity, according to the preferred embodiment of the present invention that is depicted in FIG. 5.

### DESCRIPTION OF THE PREFERRED EMBODIMENTS

The present embodiments comprise an apparatus and a method for allowing SIM-type authentication on conventional hotspots or access points. The GSM challenge is placed in advance on the SIM card and the password field provided by the standard hotspot authentication is used to return the challenge response (SRES).

Advance placement of the GSM challenge is carried out during a previous IP session with the communication entity. Two alternatives are provided for such a previous IP session. A first method is to obtain challenges during existing IP sessions and cache them for future use, so that the communication entity has a challenge ready in its cache should it connect to a hotspot. A request for authentication is issued to the cellular network and a challenge is produced and cached at both the network and the communication entity for later use.

A second method is carried out directly at the hotspot and involves authorizing the hotspot to allow a full IP connection for a short space of time, during which the challenge is transferred. The connection is then closed.

The principles and operation of a network node and method according to the present invention may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. In addition, it is to be understood that the phraseology and terminology employed herein is for the purpose of description and should not be regarded as limiting.

A communication entity may be understood as a laptop or notebook computer, preferably equipped with personal computer memory card industry association (PCMCIA) card, a dual-mode phone, a wireless personal digital assistant (PDA), a mobile phone with a WLAN connection, or any other type of terminal that supports WLAN connections. The communication entity may also be understood as an arrangement of a SIM based mobile phone and a communication entity with a WLAN connection which are associated with a common subscriber or any other arrangement of a communication entity which is designed to be connected to a cellular network and a communication entity which is designed to be connected to a computer network.

A computer network may be understood as an. IP-based network, the Internet, a local Ethernet, a Virtual Private Network (VPN), a WLAN, a LAN, a wireless network, or the combination thereof.

An access point may be understood as a hotspot, a Wi-Fi access point, a Wi-max access point, any other access point that allows a subscriber to access a computer network a communication entity, or the combination thereof.

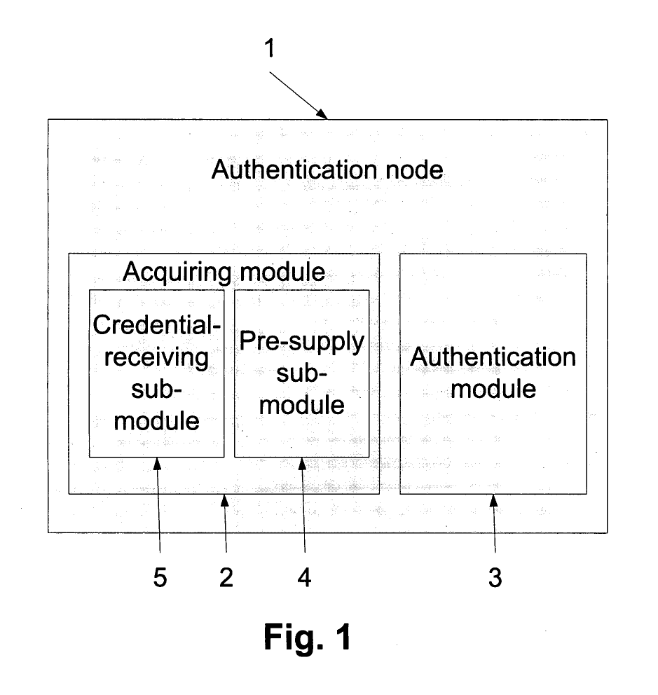

Reference is now made to FIG. 1, which is a schematic illustration of an access point authentication node 1, such as an AAA server, which manages access of communication entities to access points, according to a preferred embodiment of the present invention. As further described below, the authentication node 1 is designed for connecting a communication entity (not shown) to a hotspot (not shown). Herein the terms ‘access point’ and ‘hotspot’ are used interchangeably.

As depicted in FIG. 1, the authentication node 1 comprises a number of modules. One of the modules is an acquiring module 2 that receives requests from the communication entity. The acquiring module 2 allows the establishment of a direct connection with the communication entity. The request is preferably an authentication request, such as a random number challenges (RAND) request, and may be received from a SIM-based mobile phone, via an IP based connection. The challenge request comprises an identification of the communication entity, preferably an IMSI. Using the IMSI, the authentication node 1 sends a request to the cellular network, using the authentication module 3. Preferably, the request is an SS7 MAP Authentication request that includes the IMSI of the requesting communication entity. The authentication node 1 then receives from the cellular network, via an appropriate interface, a GSM triplet, as defined in the background section. The GSM triplet is preferably generated as a response to the SS7 map authentication request. As described above, such a GSM triplet comprises the RAND, currently a 128-bit random number, the signed response (SRES) and communication keys (Kc). The acquiring module 2 extracts the RAND and forwards it to the communication entity, preferably via the IP based connection, as a response. The Rand, essentially the challenge, is cached at the communication entity for future use as will be explained. The acquiring module 2 at the same time stores or caches the SRES and the RAND for authenticating network access by the communication entity later on, as further described below.

In order to achieve the above, the acquiring module 2 comprises a pre-supply sub-module 4, which is used for pre-supplying a challenge to a communication entity, as described above, and a credential-receiving sub-module 5 for receiving data that has been sent as a password to the access network, preferably as a response to the pre-supplied challenge, as will be explained below. Such data can be encoded as the credentials of HTTP POST and HTTP GET commands.

Another module is an authentication module 3, which is used for communicating with one or more access points and verifying that the correct challenge response has been received. Such an interface enables the authentication node 1 with the ability to be responsible for authenticating and authorizing access for a subscriber, associated with a certain SIM, to a hotspot. The authentication node 1 is designed to receive an authentication request from an access point (not shown) and to reply, as described below. The authentication module itself compares the challenge it has previously cached with the answer that the SIM has made based on its cached challenge.

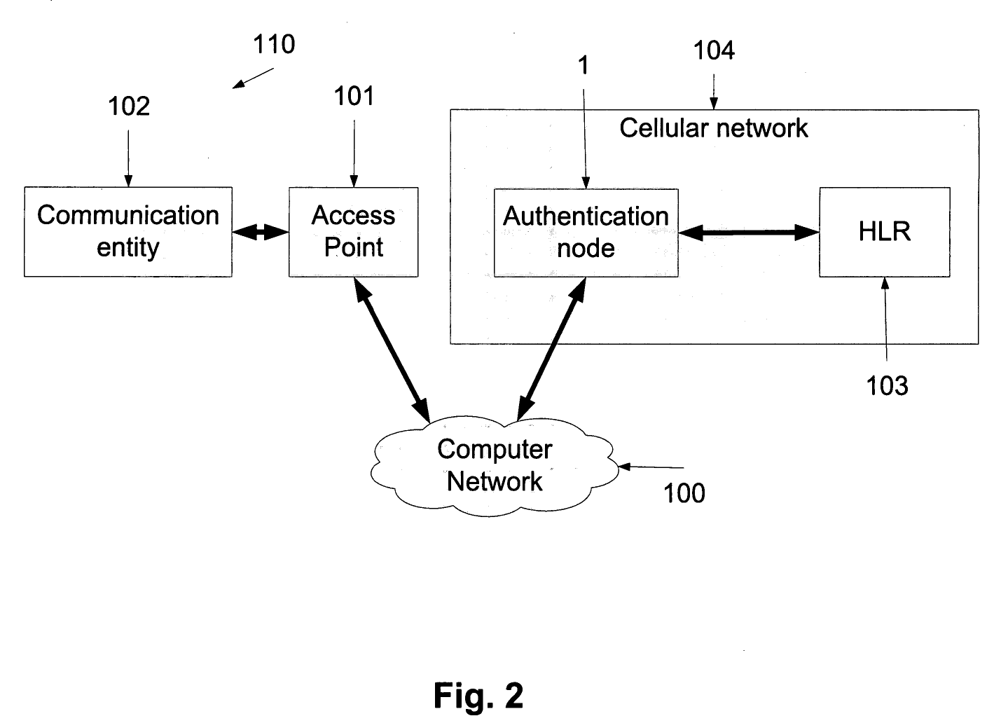

Reference is now made to FIG. 2, which is an exemplary high-level network diagram of a system 110 for authenticating access to a computer network 100, according to one preferred embodiment of the present invention.

As depicted in FIG. 2, an access point 101 is connected to a computer network 100, such as an IP/Internet network. The authentication node 1 is preferably as depicted in FIG. 1; however, FIG. 2 further depicts an access point 101 and a communication entity 102. In FIG. 2 the authentication node 1 is connected to an HLR 103 of a certain cellular communication network 104.

As depicted in FIG. 2, the authentication node 1 is connected to the HLR 103. The HLR 103 stores mobile subscribers' user data, as further described below, and the data is accessible to the authentication node 1. The authentication node 1 may be physically separate from the HLR 103, and, the communication between the authentication node 1 and the HLR 103 may use a mobile application part (MAP) protocol. In another embodiment, the authentication node 1 and the HLR 103 can be a single logical entity.

The access point 101 is preferably a WLAN access point that functions according to the IEEE's specification 802.1x. The access point 101 communicates, via an appropriate communication interface, with a computer network 100 that is preferably an IP based network, and may for example be the Internet. At the same time, the access point 101 may also be connected, via an appropriate communication interface, to the authentication node 1.

It should be noted that the depicted access point 101 may be one out of a number of access points that are connected to the authentication node 1 and to the computer network 100 which are, for the sake of clarity, not depicted in FIG. 2. In addition, the depicted communication entity 102 may be any mobile device that wants a connection via the access point.

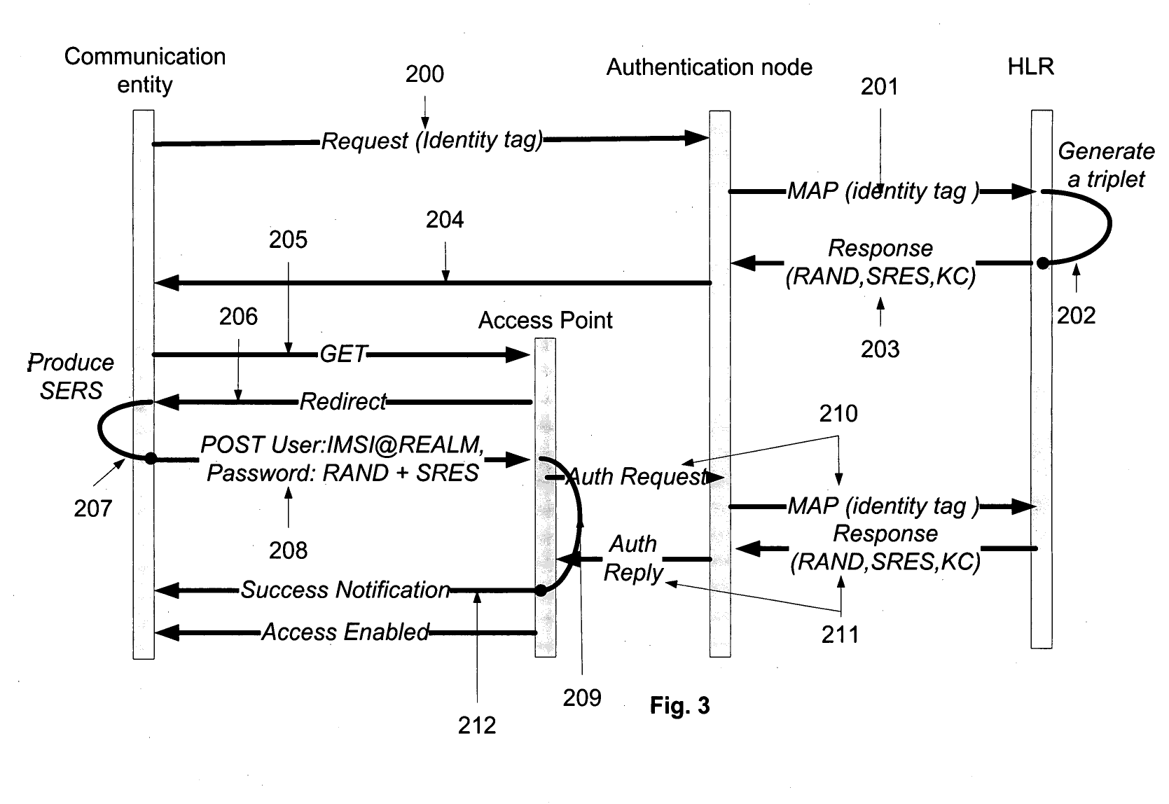

Reference is now made jointly to FIG. 2, previously described, and to FIG. 3, which is an exemplary sequence chart of a method for SIM-based authentication in network-access, according to the preferred embodiment of the present invention. The SIM-based authentication which is depicted in FIG. 3 is based on a direct connection between the communication entity and the authentication node 1 which is established before the communication entity establish a connection with the access point 101. The access point 101 is defined to allow network access to authorized communication entities, as described in the background section. The access point 101 does not allow unauthorized communication entities to establish a bidirectional connection with the authentication node 1 but rather expects the communication entity to provide a username and password, which can be checked before allowing bidirectional access. In one embodiment of the present invention, the establishment of a direct connection that does not go through the access point allows an unauthorized communication entity to acquire a challenge that can later be used as a password to access the network, as described below.

The method for SIM-based authentication, which is depicted in FIG. 3, can be divided to two stages. During the first stage, the communication entity 102 acquires a challenge from an authentication node 1, which it caches. The authentication node is associated with cellular network 104 but may be accessed for this purpose via an existing IP connection. During the second stage, the communication entity 102 uses the acquired and cached challenge and produces the challenge response SRes, which has been generated based thereupon, for authenticating a network-access via the access point 101. Authentication node 1 has also cached the SRes as produced by the HLR, so the generated SRes from the authenticating unit can be compared with the cached SRes at the authentication node.

In particular, when a subscriber of a communication entity desires to establish a connection with the computer network 100, via the access point 101, it first establishes an IP connection with the authentication node 1. As shown at 200, the connection allows the communication entity 102 to send a challenge request with its IMSI. As shown at 201, the authentication node 1 extracts the IMSI from the request and sends it, in a SS7 MAP Authentication request, to the HLR 103. The HLR 103 receives the MAP Authentication request and extracts the IMSI. Based on the received IMSI, the HLR 103 then generates a GSM triplet, as described in the background section. The RAND, which is preferably a 128-bit challenge, the SRES and the Kc are then forwarded to the authentication node 1, as shown at 203. The authentication node 1 extracts the RAND from the message received from the HLR and forwards it to the communication entity 102, via the IP connection (not shown), as shown at 204. The RAND is preferably cached in the communication entity for future use when connecting via a hotspot. In parallel, the authentication node 1 caches the RAND, the SRES and the Kc for authentication in the following steps, as described below in relation to step 209.

Now, after the communication entity 102 acquired the challenge, the first stage is completed. During the next stage, which is described hereinafter, the communication entity 102 can issue a respective SRES and use it for authenticating a network access, as described below. It should be noted that the next step does not have to occur immediately after the completion of the first stage. The challenge that has been acquired and stored during the first step can be used later on with one or more access points, which are connected to the authentication node 1.

The second stage occurs when, as shown at 205, the communication entity 102, now armed with a cached SRes, establishes a connection with the access point by issuing an HTTP GET command to the access point 101.

As shown at 206, the access point 101 redirects the request to a designated webpage, which is designed to receive a password and preferably a subscriber name, all in accordance with the hotspot Radius or Diameter protocols. Then, as shown at 207, the communication entity 102 uses the RAND, which has been retrieved in step 204, to produce the SRES. The process of producing SRES from RAND is generally well known and is as described above in the background.

Then, as shown at 208, the communication entity 102 issues a POST request, that includes a subscriber name and a password and submits it to the access point 101 via the web page. The subscriber name and the password are included in the body of the post as credentials. The password is generated according to the produced SRES and the RAND. The subscriber name is preferably the IMSI of the communication entity 102 and a predefined domain term. In the drawings, the predefined domain term is “REALM”, giving a user name of the form IMSI@REALM.

Then, as shown at 209, the access point 101 receives the request, unpacks the subscribers' credentials, and maps them from the remote authentication dial-in subscriber server/service (RADIUS) message, into an authentication request, which is sent to the authentication node 1.

The authentication node 1, in combination with the HLR 103, authenticates and authorizes the communication entity 102, and if the authentication and authorization are successful, the authentication node 1 returns a validity message to the access point 101. In particular, in order to authenticate the communication entity 102 for granting network-access, the authentication node 1 matches the earlier cached RAND and SRES with the RAND and SRES, which are included in the message, received from the communication entity 102. Preferably, the IMSI included in the user name is used to identify the correct cached Rand and corresponding SRES at the authentication node.

Preferably, in order to verify the current service subscription of the relevant subscriber, the access point 101 is designed to extract the IMSI from the received message and to forward it to the authentication node 1 in an additional authentication request, as before an SS7 MAP authentication request with the received IMSI. The request is forwarded to the HLR 103, as shown at 210. The HLR receives the IMSI, verifies whether the SIM card, which is associated with the received IMSI, is still valid or not, and issues a further GSM triplet, as shown at 211, as the HLR thinks this is a regular authorization. However, this latter GSM triplet is not used directly in an authorization procedure. Rather the very fact that the triplet is issued is used by the authorization server to ascertain that the IMSI is still valid. Such a precaution is used here because the basic authentication is based on a challenge that may have been issued days or weeks before, and in the meantime the HLR may know that the particular SIM card has been lost, stolen or otherwise invalidated.

Returning to the authentication process and if the cached RAND and SRES match the credentials received from the mobile device, then, as long as the HLR approves the IMSI, the authentication node 1 sends a message, such as an Auth Reply Accept message, to the access point 101. Then, as shown at 212, the access point 101 sends a success notification to the communication entity 102. The success notification tells the access point to allow the requested network connection and billing may be carried out through the user's GSM telephone account. At that point, as the access point 101 receives the authorization message, the access point 101 allows data traffic to be exchanged between the computer network 100 and the communication entity 102.

In such an embodiment, it becomes possible to implement the 802.1x authentication mechanism without the need to update all the access points that support 802.1x, because the system implements authentication functionality into a single authentication node 1 instead of into a number of access points.

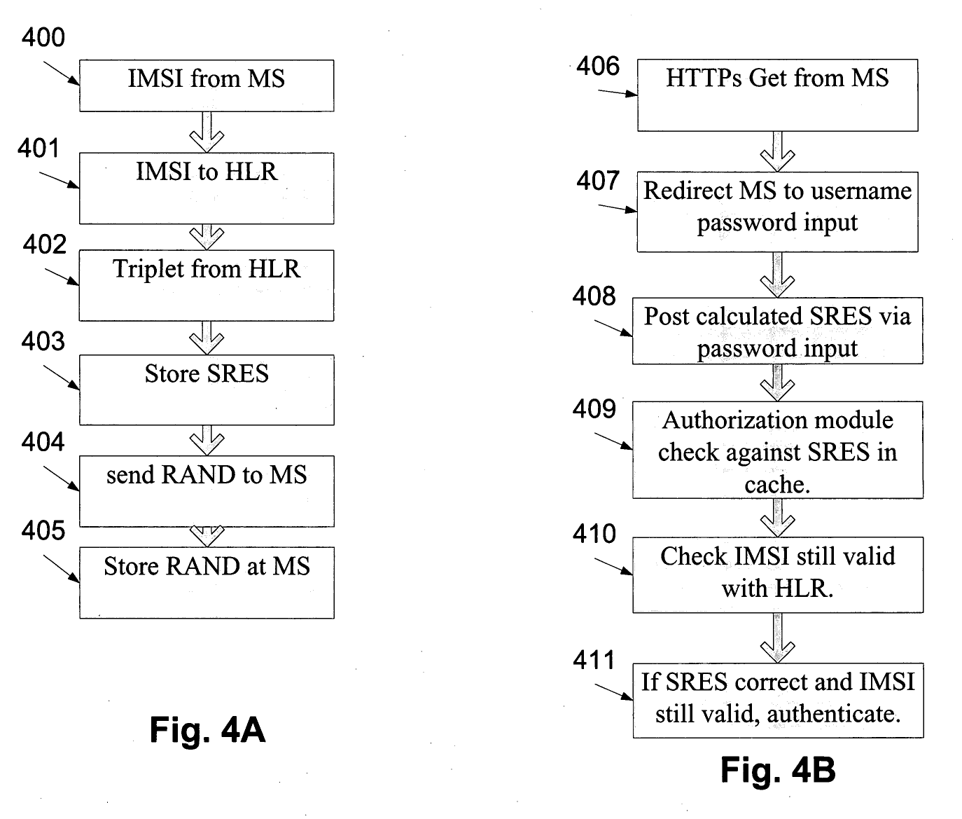

Reference is now made to FIGS. 4A and 4B, which are respectively flowcharts of the first and second stages of an exemplary method for enabling network-access to a communication entity, according to a preferred embodiment of the present invention.

During the first step of the first stage, as shown at 400 of FIG. 4A, a challenge request message that comprises an IMSI, of a communication entity, such as a mobile phone, is received by the authentication node. The request is received via any IP based connection. Then, as shown at 401, the IMSI is forwarded to the HLR. In the following step, as shown at 402, the HLR issues a GSM triplet, as shown at 402, and forwards it to the authentication node 1. This stage allows the authentication node to acquire the challenge and the SRES are from a cellular communication network, as a response to receiving the IMSI. Preferably, the challenge and the SRES are taken from a GSM triplet generated by the HLR of the cellular communication network, as described above. As shown at 403, the acquired challenge and SRES are stored on the local memory of the authentication node or on any other storage unit that is accessible by the authentication node. The acquisition is performed using the IMSI, as described above. At this time, the acquired challenge, such as a RAND, is transmitted to the communication entity, as shown at 404, preferably, via the predefined IP based connection. After the communication entity has been provided with the acquired challenge, which it stores as shown at 405, the first stage has been completed. As described above, the challenge allows the communication entity to issue a SRES. The acquired challenge and SRES are now stored in the memory of the authentication node for the network access authentication which is performed during the next stage.

During the first step of the second step, as shown at 406 of FIG. 4B, an HTTP GET command is received from the communication entity. Based thereupon, as shown at 407, the communication entity is redirected to username password input. Then, as shown at 408 a request message with the challenge and SRES is received, preferably at the authentication node, from an access point of a computer network. Such a request message is encoded, preferably, as an HTTP POST command that comprises the challenge and SRES, as described above, via the password input. In the following step, as shown at 409, the requested network-access is authenticated by matching, as described above, the acquired unique challenge and SRES, which is stored on the memory of the authentication node or accessible thereto, and the challenge and SRES, which are stored in the message that is received from the access point. During the next step, as shown at 410, the validity of the IMSI is verified against the HLR. Based upon the matching and the verification, as shown at 411, the authentication node can authenticate the network access. Preferably, a message that indicates whether the network-access has been authenticated or not is sent to the access point or to a network-access server manager that is related to the computer network.

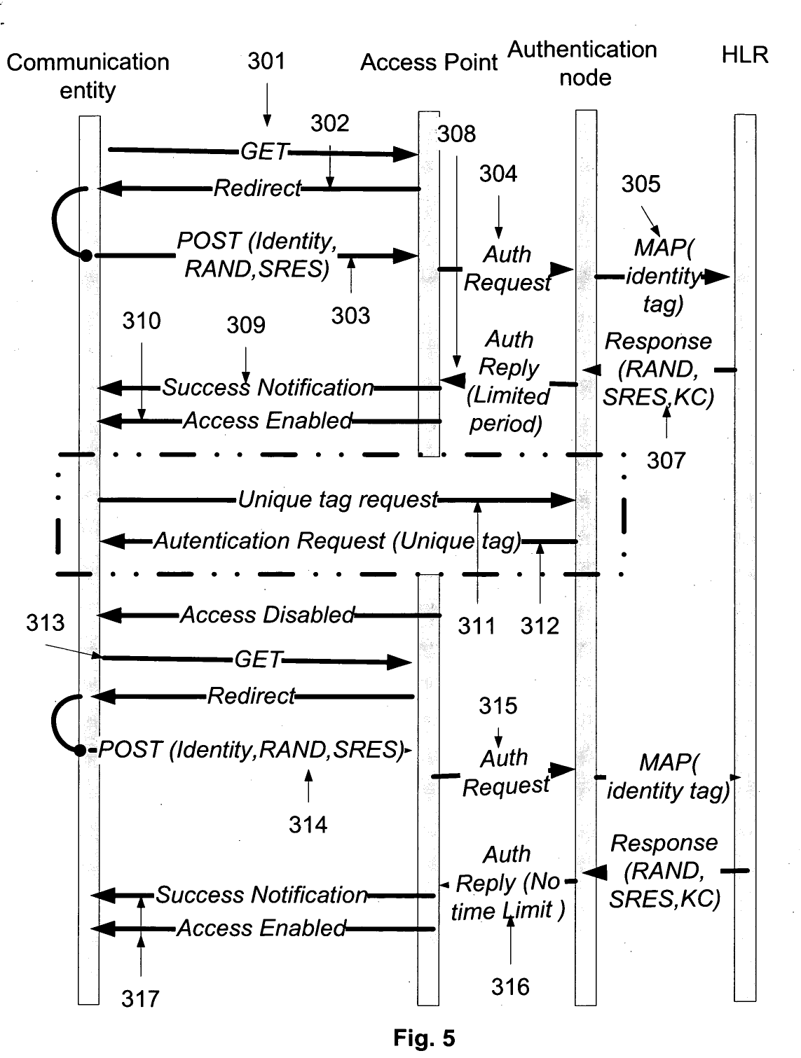

Reference is now made jointly to FIG. 2, previously described, and to FIG. 5, which is another exemplary sequence chart of another method for SIM-based authentication in network-access, according to a further preferred embodiment of the present invention.

As described above, the method for SIM-based authentication in network-access that is depicted in FIG. 3 is a two-step method in which a challenge is acquired via a previous IP based connection. The method for SIM-based authentication of network-access that is depicted in FIG. 5 is also a two steps method. However, in the depicted method the challenge is acquired without such a previous IP based connection. In the method depicted in FIG. 5, the initial communication is established via the access point 101. As there is no bidirectional communication in such an initial communication, the GSM challenge is delivered during a limited opening period. In such an embodiment, the authentication node 1 is designed to receive a request and to instruct the access point 101 to allow network access for a limited period. During the limited period, a full IP connection is established, allowing the communication entity to request and receive a challenge from the authentication node 1. After the challenge has been acquired, the temporary connection is disconnected, and the second stage can be initiated. The second stage is preferably the same as the second stage that is depicted in relation to FIG. 3.

In particular, during the authentication process, as shown at 301, when a subscriber of a communication entity desires to establish a connection with the computer network 100, via the access point 101, it issues a HTTP GET command for the access point 101. Then, as shown at 302, the access point 101 redirects the request to a webpage that is designed to receive a password and preferably a subscriber name. At this point, as shown at 303, the communication entity 102 issues an HTTP POST command. The communication entity 102 fills the subscriber field in the HTTP POST command with its IMSI and a predefined domain code, herein shown as “REALM”, preferably as described above. The password field is left empty. As such, HTTP POST commands can be submitted without any authorization from the computer network 100 or the access point 101, the message can be sent before any network connection has been authorized, as other HTTP POST commands.

At this time, as shown at 304, the access point that receives the HTTP POST command forwards it as an ordinary RADIUS access request to the authentication node 1. In the following step 305, the authentication node extracts the IMSI from the message and uses the IMSI in an SS7 MAP Authentication request that is forwarded to the HLR 103. The HLR 103 chooses a 128-bit challenge RAND and produces accordingly a GSM triplet, including the expected answer SRES as further described above and shown at 306. Then, as shown at 307, the HLR 103 sends the GSM triplet to the authentication node 1. The authentication node 1 extracts the credentials of the received GSM triplet and caches them. Then, as shown at 308, the authentication node 1 sends an Auth Reply Accept message back to the access point 101. The Auth Reply Accept message defines a certain period, such as 30 seconds. The access point 101 extracts the period from the received message and accordingly allows a temporary network connection, which is preferably limited to a duration equivalent to the extracted period. The access point 101 then sends a success notification to the communication entity 102 and preferably a notification that the access is enabled, as respectively shown at 309 and 310.

The enabled connection allows the communication entity 102 to issue a proprietary RAND request and to send it directly to the authentication node 1. In the following steps, as shown at 311 and 312, the authentication node 1 receives the RAND request and issues a RAND reply with the RAND that has been cached in its memory, as described in relation to step 307. When the period expires, the connection is terminated. Thus the GSM challenge is now stored at the communication entity 102.

At this time, the communication entity 102 can use the received RAND to authenticate access to the computer network 100, via the access point 101.

At this point, the temporary connection has been terminated and there are no active connections between the access point 101 and the communication entity 1. The communication entity 1, having received the 128-bit RAND from the authentication node establishes a standard network connection with the hotspot.

In the following step, as shown at 313, the communication entity 1 establishes a connection with the access point 101 and issues an HTTP GET command, as described above. The access point redirects the request as described in relation to step 302. The communication entity 1 uses the 128-bit RAND to produce the SRES, as described in relation to FIG. 3, and issues an HTTP POST command. As shown at 314, the issued HTTP POST command is then forwarded. The subscriber name and the password are included in the body of the request as credentials. The password is generated according to the produced SRES and the RAND. The subscriber name is preferably the IMSI of the communication entity 102 with the predefined domain term, in the case illustrated “REALM”. The resulting user name is thus IMSI@REALM.

As shown at 315, the Access point passes the HTTP POST command as an ordinary RADIUS request to the authentication node 1, as described above. The authentication node 1 can now match the RAND and SRES from the RADIUS request with the RAND and SRES, which have been previously cached, as described in relation to step 308, thereby authenticating the data received from the communication entity 1. As shown at 316 and 317 the authentication node 1 sends an Auth Reply Accept to the access point 101, and the access point accordingly issues a success notification and sends it to the communication entity 1. The success notification enables the establishment of a regular network connection without a time limit between the communication entity 1 and the computer network 100, and allows the user's GSM account to be billed for the access.

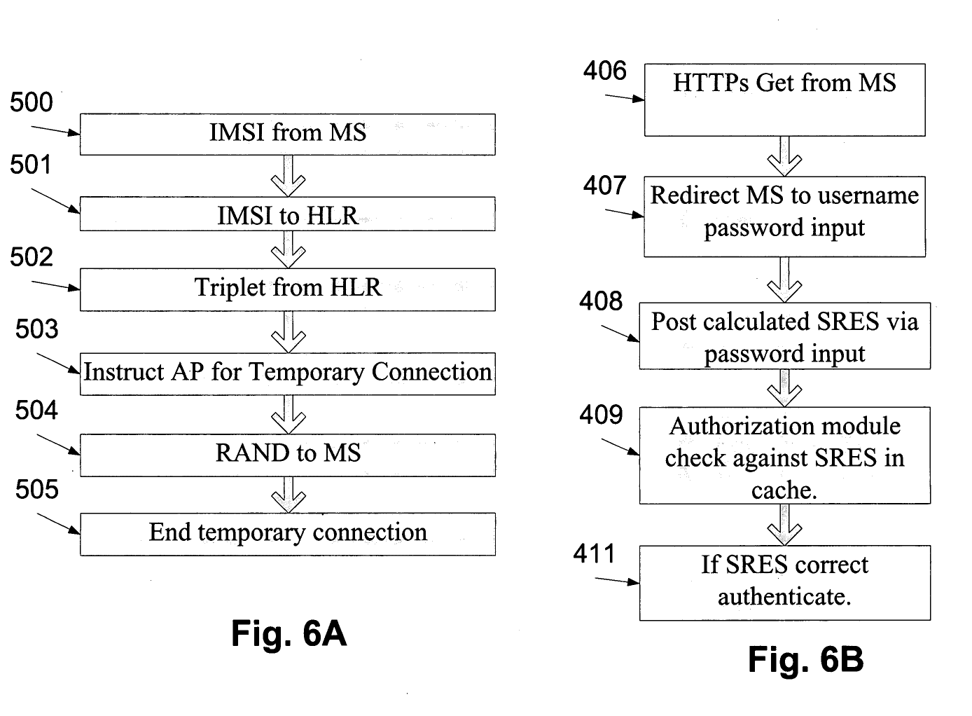

Reference is now made to FIGS. 6A and 6B, which are respectively flowcharts of the first and the second stages of another exemplary method for enabling network-access to a communication entity, according to a preferred embodiment of the present invention.

FIG. 6A depicts the steps of the first stage of the method for enabling network-access that is depicted in FIG. 5. As described above, unlike the first stage of the method for enabling network-access that is depicted in FIG. 4A, in this method the initial connection is established via the access point and not via a predefined connection. The steps of the second stage of the method are as in FIG. 6B which is the same as FIG. 4B except that the stage of checking that the IMSI is still valid, stage 410, may be dispensed with since the triplet has been obtained in the past few seconds.

During the first step 500 of the first stage that is depicted in FIG. 6, a request that includes the IMSI of a communication entity is received, preferably at the authentication node, from a communication entity. The request is preferably an HTTP POST command, which is received, as described above, via an access point that is connected to a computer network. During the following step, as shown at 501, the received IMSI is forwarded to the HLR for acquiring a challenge and a SRES from a cellular communication network, as described in relation to FIG. 5. Then, as shown at 502, the HLR issues a GSM triplet and transmits it to the authentication node. In the following step, as shown at 503, the access point is instructed by the authentication node to establish a temporary connection between the communication entity and a computer network for a predefined period. The temporary connection allows the authentication node to provide the acquired challenge to the communication entity, as shown at 504. Now, as shown at 505, after the acquired challenge has been provided to the communication entity the temporary connection is ended.

As described above, the communication entity acquires network access according to a SIM-based authentication procedure, where the access network is acquired over an access point supporting only a password-based communication protocol. In order to allow the implementation of such a SIM-based authentication procedure, the communication entity comprises a modified user client, which is a regular GSM authentication module with the difference that it is able to cache Rand challenges for later use, and is then able to post the challenge result over a username/password request. In the one case, the client acquires a challenge from a cellular network via an IP-based connection as per FIG. 4A, and later use means significantly later, that is when next connecting to a hotspot. In the system of FIG. 5 later use means a few seconds later after the temporary connection has terminated. The challenge is used by the communication entity for generating a challenge response, such as a SRES, in the usual way. The challenge response is included in an HTTP POST command, as described.

It is expected that during the life of this patent many relevant devices and systems will be developed and the scope of the terms herein, particularly of the terms node, authentication, network, communication, an access point, Wi-Fi, wireless, etc. are intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents, and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A method for challenge-based authentication of a communication entity to an access network, the access network using a password-based communication protocol, the method comprising:
a) pre-supplying to the communication entity a challenge, thereby allowing the communication entity to provide a challenge response;
b) supplying to the communication entity a password request;
c) receiving via said password request said challenge response; and
d) authenticating the communication entity if said challenge response is correct.

2. The method of claim 1, wherein said pre-supplying is performed via an IP-based network connection, to provide said communication entity with challenges for future connections to access networks.

3. The method of claim 2, wherein said pre-supplying comprises pre-supplying multiple challenges to said communication entity.

4. The method of claim 1, wherein communication entity comprises a member of the following group: a subscriber identification module (SIM) card and a universal SIM card.

5. The method of claim 2, wherein said authenticating comprises checking that said SIM card is still valid by requesting a new challenge substantially simultaneously with said authentication.

6. The method of claim 1, wherein said pre-supplying is via a temporary IP session on the access network.

7. The method of claim 1, wherein said challenge is a GSM authentication challenge.

8. The method of claim 1, further comprising a step before step a) of receiving an international mobile subscriber identity (IMSI).

9. The method of claim 8, further comprising a step before step a) of using said IMSI to obtain said challenge.

10. The method of claim 1, wherein said communication entity comprises a member of the following group: a laptop, a notebook computer, a notebook computer equipped with personal computer memory card industry association (PCMCIA) card, a dual-mode phone, a wireless personal digital assistant (PDA), a mobile phone with a wireless local area network (WLAN) connection, and an arrangement of a SIM based mobile phone and a communication device with a WLAN connection.

11. The method of claim 1, wherein said challenge is acquired from a home location register (HLR) of a cellular network.

12. The method of claim 11, wherein said challenge is a random number challenges (RAND) of a GSM triplet generated by said HLR.

13. The method of claim 11, wherein said challenge response is a signed response (SRES) of a GSM triplet generated by said HLR.

14. An authentication server for managing challenge based authentication from a cellular network on access networks configured for password-based authentication, the server comprising:
a pre-supply unit for pre-supplying a challenge to a communication entity;
a credential-receiving unit for receiving data sent as a password to the access network as a response to said pre-supplied challenge; and
an authorization unit for authorizing the authorization unit if the credentials correctly correspond to the pre-supplied challenge.

15. The authentication server of claim 14, wherein said pre-supply unit is configured to send said challenge via predefined IP-based connection.

16. The authentication server of claim 14, wherein said pre-supply is configured to pre-supply said challenge to said communication entity by opening a temporary IP connection over an access unit.

17. The authentication server of claim 14, wherein said pre-supply unit is configured to send said challenge as a response to an authorization request that is received from said communication entity.

18. The authentication server of claim 14, wherein said pre-supply unit is configured to communicate with a home location register (HLR) of a cellular network.

19. The authentication server of claim 18, wherein said challenge is a random number challenges (RAND) of a GSM triplet generated by said HLR.

20. A subscriber information module (SIM)-card based client for acquiring a network access, said SIM-card based client comprising:
a challenge request module for acquiring a GSM challenge;
a challenge response module configured for generating a challenge response; and
a response module for sending said challenge response as a password in a post request, thereby carrying out bi-directional authentication over a password-enabled access connection.

21. The SIM card based client of claim 20 further comprising a cache for storing said challenge until authorization is required.

22. The SIM-card based client of claim 20, wherein said SIM-card has an international mobile subscriber identity (IMSI), said challenge request module being configured to send said IMSI as a credential a username password post request.

23. The SIM-card based client of claim 20, wherein said GSM challenge is acquired via an IP-based connection.

24. The SIM-card based client of claim 23, wherein said IP-based connection is a direct connection with an authentication, authorization, accounting (AAA) server of a cellular network.

25. The SIM-card based client of claim 24, wherein said challenge request module is configured to instruct said AAA server to establish a temporary connection, said acquiring being via said temporary connection.

26. The SIM-card based client of claim 20, wherein said SIM-card based client is a member of the following group: a laptop, a notebook computer, a notebook computer equipped with personal computer memory card industry association (PCMCIA) card, a dual-mode phone, a wireless personal digital assistant (PDA), a mobile phone with a wireless local area network (WLAN) connection, and an arrangement of a SIM based mobile phone and a communication device with a WLAN connection.

27. An access point for authenticating an access network for a communication entity, the access point comprising:
a temporary access module for:
a) communicating with a cellular authorization authority to provide said communication entity with a temporary connection, and
b) to allow uploading a challenge to said communication entity during said temporary connection.
